(19) United States
(12) Patent Application Publication
(10) Pub. No.: US 2009/0070185 A1
(43) Pub. Date: Mar. 12, 2009

(54) SYSTEM AND METHOD FOR RECOMMENDING A DIGITAL MEDIA SUBSCRIPTION SERVICE

(75) Inventor: Eugene M. Farrelly, Cary, NC (US)

Correspondence Address: CONCERT TECHNOLOGY AND WITHROW & TERRANOVA, 100 REGENCY FOREST DRIVE , SUITE 160, CARY, NC, 27518, US

(73) Assignee: CONCERT TECHNOLOGY CORPORATION, Durham, NC (US)

(21) Appl. No.: 11/623,865

(22) Filed: Jan. 17, 2007

(51) Int. Cl. G06Q 30/00; G06Q 99/00; G06Q 50/00

(52) U.S. Cl. 705/10; 705/27

(57) ABSTRACT

A system and method for recommending a subscription media service for a user are provided. In general, a user profile for the user is generated. The user profile may include information such as, but not limited to, information identifying media items in the user's media collection, biographical information describing the user, demographic information describing the user, media recommendations received by the user, or any combination thereof. Based on the user profile and service profiles of a number of subscription media services, a service recommendation function generates a service recommendation for the user.

### FIELD OF THE INVENTION

The present invention relates to recommending a subscription media service for a particular user.

### BACKGROUND OF THE INVENTION

The proliferation of digital media content such as music and videos has led to the development of subscription media services. Exemplary subscription media services are Yahoo!® (Music Unlimited, Rhapsody® Unlimited, Rhapsody® To Go, Napster®, and the like. These subscription media services generally provide unlimited access to their respective catalogs of media content for a subscription fee. While the catalogs of subscription media services typically include hundreds of thousands or even millions of media items such as songs and videos, an issue still arises from the fact that there are differences in the catalogs of the subscription media services. For example, a particular service may be the exclusive distributor of music by a particular artist. Because of the differences in the catalogs, one subscription media service may be well-suited to users that like independent grunge music, another subscription media service may be well-suited to users that like modern mainstream music, and another subscription media service may be well-suited to users that like music from the 1980s. Thus, there is a need for a system and method for recommending a subscription media service to a user.

### SUMMARY OF THE INVENTION

The present invention relates to a system and method for recommending a subscription media service for a user. In general, a user profile for the user is generated. The user profile may include information such as, but not limited to, information identifying media items in the user's media collection, biographical information describing the user, demographic information describing the user, media recommendations received by the user, user preferences regarding the intended use of the media items, or any combination thereof. Based on the user profile and service profiles of a number of subscription media services, a service recommendation function generates a service recommendation for the user. In one embodiment, the service recommendation includes scores for each of the subscription media services, where the user may then select a desired subscription media service based on the scores. In another embodiment, the service recommendation includes a recommended subscription service selected by the service recommendation function for the user based on the user profile of the user.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 illustrates a system including a service recommendation function according to one embodiment of the present invention;

FIG. 2 illustrates the operation of the system of FIG. 1 according to one embodiment of the present invention;

FIG. 3 illustrates a system including a service recommendation function that considers media recommendations according to one embodiment of the present invention;

FIG. 4 illustrates the operation of the system of FIG. 3 according to one embodiment of the present invention;

FIG. 5 illustrates a system including a service recommendation function that considers media recommendations according to another embodiment of the present invention;

FIG. 6 illustrates the operation of the system of FIG. 5 according to one embodiment of the present invention;

FIG. 7 illustrates a recommendation server according to one embodiment of the present invention; and

FIG. 8 illustrates a user device according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

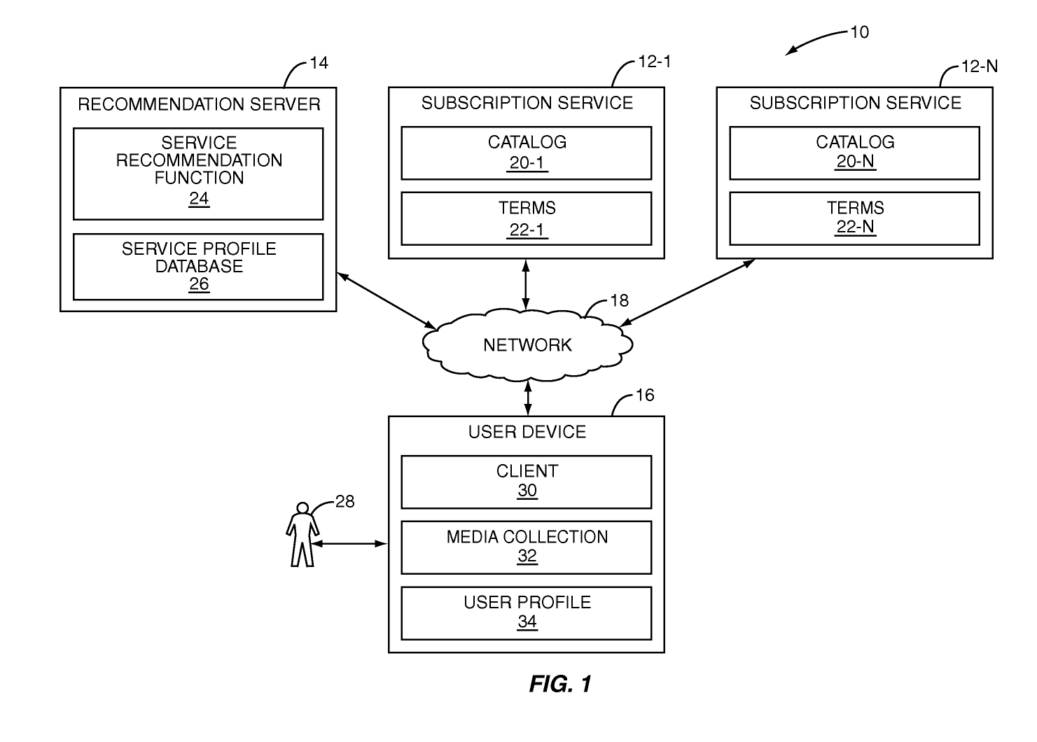

FIG. 1 illustrates a system 10 operating to provide a media service recommendation according to a first embodiment of the present invention. In general, the system 10 includes a number of subscription media services 12-1 through 12-N, a recommendation server 14, and a user device 16 interconnected by a network 18. The network 18 may be a Wide Area Network (WAN), a Local Area Network (LAN), or any combination thereof and may include wired components, wireless components, or both wired and wireless components. For example, the network 18 may be the Internet. Each of the subscription media services 12-1 through 12-N operates to provide media content such as music, movies, television programs, or any combination thereof to users for a monthly subscription fee. Individual songs, albums, movies, television shows, or the like are referred to herein as media items. Exemplary subscription media services are Yahoo!® Music Unlimited, Rhapsody® Unlimited, Rhapsody® To Go, Napster®, and the like. The subscription media services 12-1 through 12-N include catalogs 20-1 through 20-N and terms 22-1 through 22-N. The catalogs 20-1 through 20-N are the media items available from the subscription media services 12-1 through 12-N, respectively. The terms 22-1 through 22-N include information such as subscription fee and Digital Rights Management (DRM) restrictions for the subscription media services 12-1 through 12-N, respectively. The DRM restrictions may be, for example, a limit on the number of playbacks permitted for a media item, whether burning of media items to Compact Disc (CD) or Digital Versatile Disc (DVD) is permitted, whether transfer of media items to a portable media player and playback of the media items on portable media players are permitted, the number of devices to which the user may copy the media items, and the like. The terms 22-1 through 22-N may also include a list of portable media players that are compatible with the subscription media services 12-1 through 12-N.

The recommendation server 14 includes a service recommendation function 24 and a service profile database 26. The service recommendation function 24 is preferably implemented in software. However, the present invention is not limited thereto. As discussed below, the service recommendation function 24 operates to recommend one or more of the subscription media services 12-1 through 12-N for a user 28 associated with the user device 16 based on a user profile of the user 28. The service profile database 26 stores a service profile for each of the subscription media services 12-1 through 12-N. The service profiles preferably include catalog information identifying the media items in the catalogs 20-1 through 20-N and the terms 22-1 through 22-N of the subscription media services 12-1 through 12-N. In addition or alternatively, the service profiles may include statistical information describing the media items in the catalogs 20-1 through 20-N such as, for example, a genre distribution, an artist distribution, a time period distribution, or the like. Using the subscription media service 12-1 as an example, the catalog information in the service profile of the subscription media service 12-1 may include, for example, metadata describing each media item or a Globally Unique Identifier (GUID) of each media item available from the subscription media service 12-1. Metadata for a song may include, for example, the title, artist, album, release date, and the like. Metadata for a movie may include, for example, the title, list of actors or actresses starring or appearing in the movie, director, producer, date of release, and the like. Metadata for television programs may include, for example, the title, list of actors or actresses, episode number if applicable, director, producer, and the like.

The user device 16 may be, for example, a portable media player having access to the network 18 via a wired interface, a local wireless interface such as an IEEE 802.11 interface, or a wireless cellular interface such as a Global System for Mobile Communication (GSM) or 3G Wideband Code Division Multiple Access (W-CDMA) interface; a personal computer; or the like. The user device 16 includes a client 30, a media collection 32, and a user profile 34. The client 30 may be implemented in software, hardware, or a combination thereof. While the client 30 is discussed herein as being a custom application, the present invention is not limited thereto. The client 30 may alternatively be a web browser operating as an interface between the user 28 and the recommendation server 14 as will be apparent to one of ordinary skill in the art upon reading this disclosure.

As discussed below in more detail, the client 30 operates to identify media items in the media collection 32 of the user 28. In addition, the client 30 may interact with the user 28 to obtain biographical information describing the user 28, demographic information describing the user 28, user preferences, or any combination thereof. Biographical information may include information such as, for example, name, address, date of birth or age, city or state in which the user 28 was born, or the like or any combination thereof. Demographic information may include information such as, for example, gender, race, income level, or the like or any combination thereof. The user preferences may include information regarding the intended or desired use of media items.

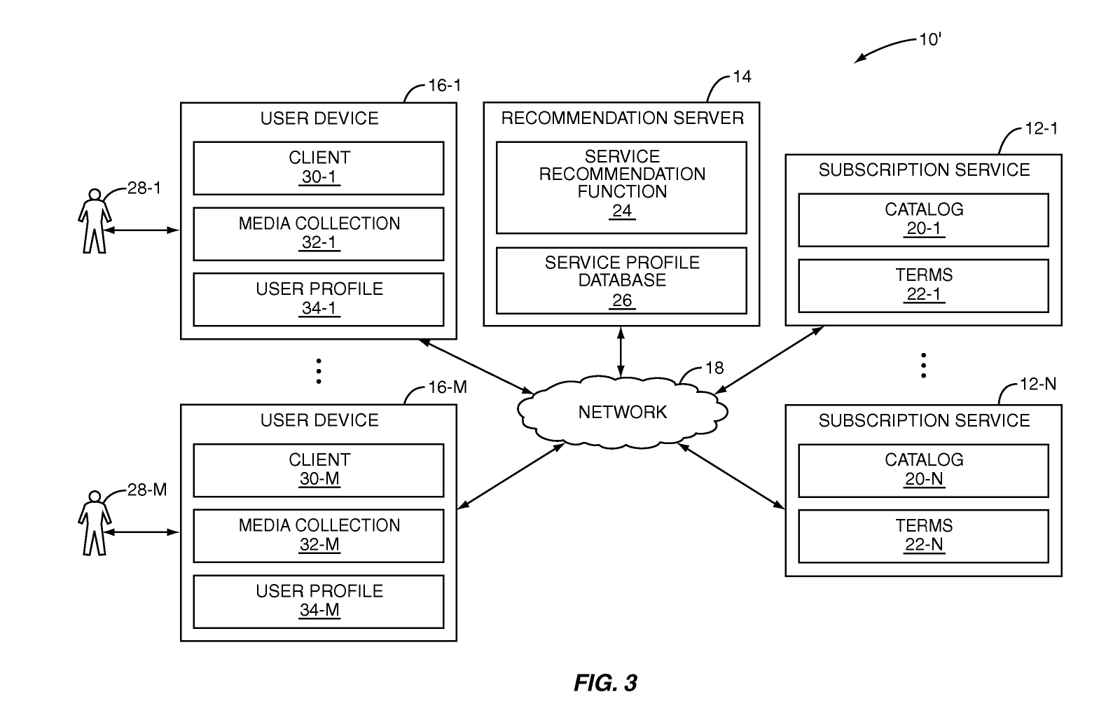

The client 30 generates the user profile 34 for the user 28, where the user profile 34 includes information identifying the media items in the media collection 32. In addition, the user profile 34 may include one or more of the biographical information describing the user 28, the demographic information describing the user 28, and the user preferences of the user 28. Note that, as described below with respect to FIGS. 3-6, the user profile 34 may also include media recommendations from other users or from a media recommendation service.

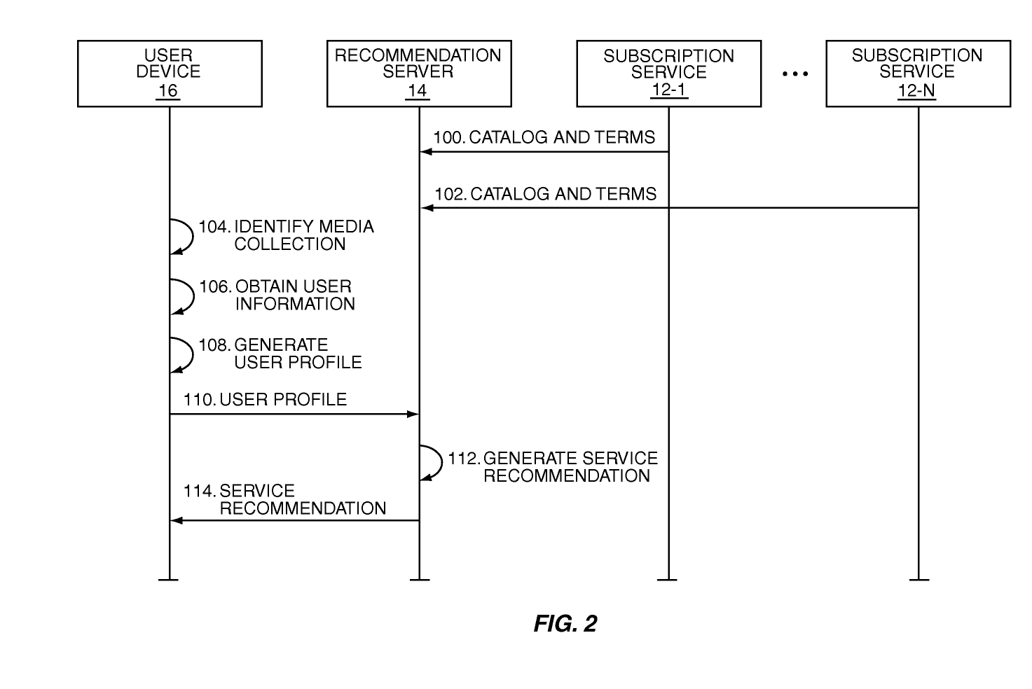

FIG. 2 illustrates the operation of the system 10 according to one embodiment of the present invention. In this example, the recommendation server 14 first obtains catalog information identifying the media items in the catalogs 20-1 through 20-N and the terms 22-1 through 22-N from the subscription media services 12-1 through 12-N (steps 100-102). The recommendation server 14 stores the catalog information and the terms 22-1 through 22-N in the service profiles for the subscription media services 12-1 through 12-N. Note that while steps 100-102 are illustrated as single steps, the recommendation server 14 may periodically request or automatically receive updates from the subscription media services 12-1 through 12-N.

At some point, the client 30 of the user device 16 identifies the media collection 32 and more specifically identifies the media items in the media collection 32 stored at the user device 16 (step 104). In one embodiment, the client 30 identifies the media items in the media collection 32 by scanning the storage of the user device 16 to locate media items. The media items may then be identified based on GUIDs or metadata stored in association with the media items such as in the associated file headers or in an associated application file. If there are no GUIDs or metadata stored in association with the media items, the client 30 may interact with a remote service to identify the media items. For example, digital fingerprints or samples of the media items may be provided to a remote service, where the remote service compares the fingerprints or samples to those of known media items in order to identify the media items in the media collection 32. The remote service may then provide GUIDs for the media items or metadata describing the media items to the user device 16. For more information, the interested reader is directed to U.S. patent application Ser. No. 11/392,051, entitled SYSTEM AND METHOD FOR ARCHIVING A MEDIA COLLECTION, and U.S. patent application Ser. No. 11/392,054, entitled SYSTEM AND METHOD FOR REFINING MEDIA RECOMMENDATIONS, both of which were filed on Mar. 29, 2006 and are hereby incorporated herein by reference in their entireties.

The client 30 also obtains user information such as biographical information, demographic information, and user preferences (step 106). The biographical information and demographic information may be obtained from the user 28. The user preferences may include information regarding the intended or desired use of media items. For example, the user preferences may include information identifying whether the user 28 will primarily use the media items on the user device 16, whether the user 28 desires to burn media items to a CD or DVD, whether the user 28 desires to transfer the media items to a portable media player if the user device 16 is not a portable media player, whether the user 28 desires to copy the media items to multiple devices associated with the user 28, and the like. The user preferences may be obtained from the user 28, inferred from previous activities and/or the type of user device 16, or both.

The client 30 uses the information identifying the media items in the media collection 32 and the user information to generate the user profile 34 of the user 28 (step 108). In one embodiment, the user profile 34 includes the information identifying the media items in the media collection 32 and the user information. In addition or alternatively, the client 30 may analyze the information identifying the media items in the media collection 32 to identify preferred genres, preferred artists, preferred time periods such as a preferred decade, and the like and/or to generate statistical information describing the media collection 32 such as, for example, a genre distribution, an artist distribution, a time period distribution, or the like. For example, the genre distribution may identify a percentage of media items in the media collection 32 for each of a number of genres. The preferred genres, preferred artists, preferred time period, and the like and/or the statistical information may then be stored in the user profile 34 of the user 28. Note that the preferred genres, preferred artists, preferred time period, and the like may additionally or alternatively be obtained from the user 28.

It should be noted that while, in this example, the client 30 generates the user profile 34, the present invention is not limited thereto. In an alternative embodiment, the client 30 provides information identifying the media items in the media collection 32, demographic information, biographical information, and user preferences related to intended uses of media content to the recommendation server 14. In response, the recommendation server 14 generates the user profile 34. Generation of the user profile 34 may include analyzing the information identifying the media items in the media collection 32 to identify preferred genres, preferred artists, preferred time periods such as a preferred decade, and the like and/or to generate statistical information describing the media collection 32 such as, for example, a genre distribution, an artist distribution, a time period distribution, or the like.

The client 30 of the user device 16 then sends the user profile 34 to the recommendation server 14 (step 110). The client 30 may send the user profile 34 as part of a request for a service recommendation, where the request may be initiated by the user 28 or by the client 30 based upon a triggering event.

In response, the service recommendation function 24 of the recommendation server 14 generates a service recommendation for the user 28 based on the user profile 34 (step 112). The service recommendation may include scores or rankings of all of the subscription media services 12-1 through 12-N, scores or rankings for one or more of the subscription media services 12-1 through 12-N having scores or rankings above a predetermined threshold or having the top X scores where X is some desired number, or information identifying one or more of the subscription media services 12-1 through 12-N recommended for the user 28.

In one embodiment, the service recommendation function 24 generates the service recommendation by comparing the user profile 34 to the service profiles of the subscription media services 12-1 through 12-N. More specifically, the service recommendation function 24 may score or rank the subscription media services 12-1 through 12-N based on comparisons of the user profile 34 to the service profiles of the subscription media services 12-1 through 12-N. In order to perform the comparisons, the service recommendation function 24 compares the media items in the media collection 32 and optionally information obtained by analyzing the media items in the media collection 32 such as preferred genre, preferred artists, preferred time period, statistical information, or the like to the media items or the statistical information describing the media items in the catalogs 20-1 through 20-N of the subscription media services 12-1 through 12-N. In addition, the service recommendation function 24 may compare the user preferences related to the desired use of media items by the user 28 in the user profile 34 to the terms 22-1 through 22-N of the subscription media services 12-1 through 12-N. Based on these comparisons, the service recommendation function 24 scores or ranks each of the subscription media services 12-1 through 12-N. Thus, in general, the subscription media services 12-1, 12-N whose catalog 20-1, 20-N and terms 22-1, 22-N have the highest correlation to the user profile 34 of the user 28 will have the highest score or ranking while the subscription media service 12-1, 12-N whose catalog 20-1, 20-N and terms 22-1, 22-N have the lowest correlation to the user profile 34 of the user 28 will have the lowest score or ranking. Note that in this example, a high score corresponds to a high correlation. However, the comparison algorithm may alternatively be such that a low score corresponds to a high correlation.

In another embodiment, the service recommendation function 24 may additionally or alternatively consider previous service recommendations to other users having biographical information and/or demographic information similar to that of the user 28. This may be particularly beneficial if the user 28 does not have a media collection, or if the number of media items in the media collection 32 is less than some minimum value such as, for example, ten media items.

Note that in one embodiment, the user 28 may assign weights to the different components of the user profile 34 to be used in generating the scores for the subscription media services 12-1 through 12-N. For example, the user 28 may assign greater weights to the information identifying the media items in the media collection 32 and the user preferences related to intended use of media items and lesser weights to the biographical information and demographic information. The service recommendation function 24 may then use the weights when generating scores or rankings for the subscription media services 12-1 through 12-N based on comparisons of the user profile 34 to the service profiles of the subscription media services 12-1 through 12-N.

Once the service recommendation is generated, the service recommendation function 24 of the recommendation server 14 sends the service recommendation to the user device 16 (step 114). Again, the service recommendation may include scores or rankings of all of the subscription media services 12-1 through 12-N, scores or rankings for one or more of the subscription media services 12-1 through 12-N having scores or rankings above a predetermined threshold or having the top X scores where X is some desired number, or information identifying one or more of the subscription media services 12-1 through 12-N recommended for the user 28. In response to receiving the service recommendation, the client 30 may optionally enable the user 28 to register with one or more of the subscription media services 12-1 through 12-N as desired by the user 28.

FIG. 3 illustrates the system 10′ according to a second embodiment of the present invention. The system 10′ is substantially the same as the system 10 of FIGS. 1-2. However, in this embodiment, the service recommendation function 24 additionally or alternatively considers media recommendations when generating service recommendations. More specifically, the system 10′ includes the subscription media services 12-1 through 12-N, the recommendation server 14, and a number of user devices 16-1 through 16-M having associated users 28-1 through 28-M. In this example, peer-to-peer (P2P) media recommendations are exchanged between the user devices 16-1 through 16-M. For example, the user device 16-M may provide media recommendations to the user device 16-1 as media items are played at the user device 16-M. The media recommendations identify the media items played at the user device 16-M and may be transferred to the user device 16-1 via the network 18 or by a local wireless communication link between the user devices 16-1 and 16-M. Additionally or alternatively, the user 28-M of the user device 16-M may initiate the transfer of a recommended playlist or more generally information identifying one or more recommended media items to the user device 16-1.

Note that while P2P media recommendations are discussed herein, the present invention is not limited thereto. Recommendations from other sources, such as a third party recommendation service, may additionally or alternatively be considered. For more information regarding an exemplary P2P media recommendation system, the interested reader is directed to U.S. patent application Ser. No. 11/484,130, entitled P2P NETWORK FOR PROVIDING REAL TIME MEDIA RECOMMENDATIONS, filed on Jul. 11, 2006; U.S. patent application Ser. No. 11/609,945, entitled MAINTAINING A MINIMUM LEVEL OF REAL TIME MEDIA RECOMMENDATIONS IN THE ABSENCE OF ONLINE FRIENDS, filed on Dec. 13, 2006; U.S. patent application Ser. No. 11/609,962, entitled MATCHING PARTICIPANTS IN A P2P RECOMMENDATION NETWORK LOOSELY COUPLED TO A SUBSCRIPTION SERVICE, filed on Dec. 13, 2006; and U.S. patent application Ser. No. 11/609,948, entitled SYSTEM AND METHOD FOR IDENTIFYING MUSIC CONTENT IN A P2P REAL TIME RECOMMENDATION NETWORK, filed on Dec. 13, 2006, all of which are hereby incorporated herein by reference in their entireties.

The client 30-1 of the user device 16-1 stores the media recommendations or at least a number of the most recent media recommendations as part of the user profile 34-1. The service recommendation function 24 may then use the media recommendations when generating the service recommendation for the user 28-1 of the user device 16-1. Note that while the discussion herein focuses on the user device 16-1, the discussion is equally applicable to the other user devices 16-2 through 16-M.

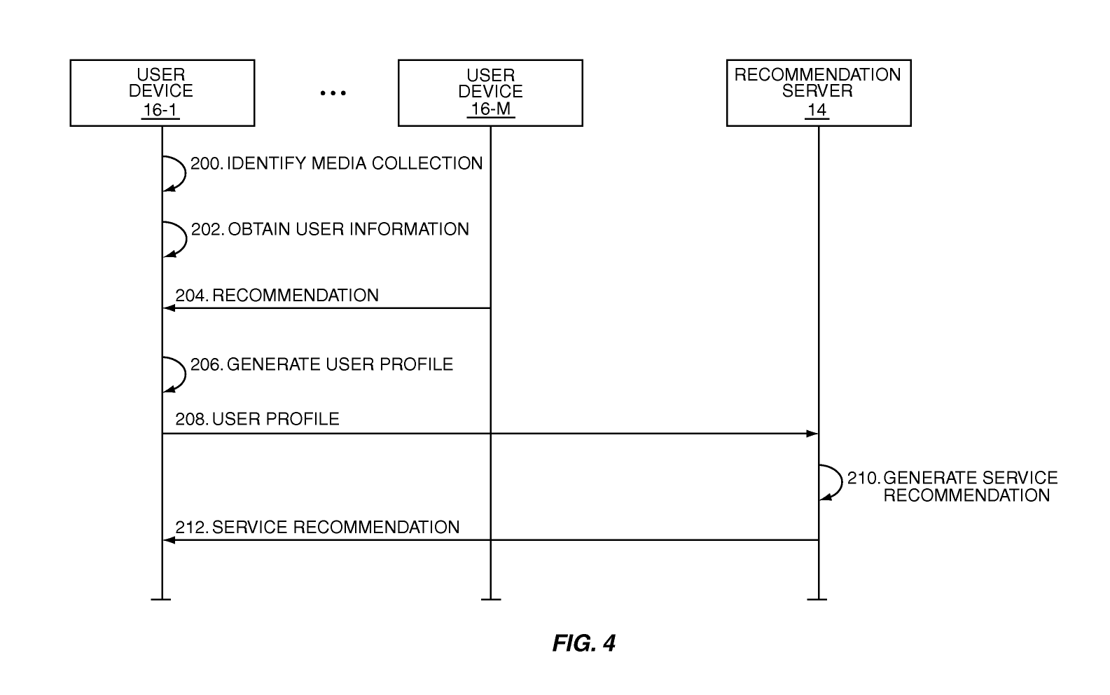

FIG. 4 illustrates the operation of the system 10′ of FIG. 3 according to one embodiment of the present invention. Note that while not illustrated for clarity, the service recommendation function 24 obtains the catalog information identifying the media items in the catalogs 20-1 through 20-N and the terms 22-1 through 22-N from the subscription media services 12-1 through 12-N at some point either before or during the illustrated process.

As discussed above, the client 30-1 of the user device 16-1 identifies the media collection 32-1 or more specifically the media items in the media collection 32-1 (step 200) and optionally obtains the user information (step 202). Again, the user information may include biographical information, demographic information, and user preferences. In addition, the user device 16-1 also receives a media recommendation from the user device 16-M (step 204). The media recommendation identifies one or more media items that are recommended to the user 28-1. The client 30-1 then generates the user profile 34-1 for the user 28-1 (step 206). Note that the client 30-1 may alternatively generate the user profile 34-1 prior to receiving the media recommendation and update the user profile 34-1 in response to receiving the media recommendation. In this embodiment, the user profile 34-1 includes the media recommendations from the user device 16-M and optionally one or more prior media recommendations from the user device 16-M and/or other user devices. The user profile 34-1 may also include information identifying the media items in the media collection 32-1, the user information, and information inferred from the media items in the media collection 32-1 such as, for example, preferred genres, preferred artists, preferred time periods, genre distribution, artist distribution, time period distribution, or the like.

The user device 16-1 then sends the user profile 34-1 to the recommendation server 14 (step 208). Again, it should be noted that while, in this example, the client 30-1 generates the user profile 34-1, the present invention is not limited thereto. In an alternative embodiment, the recommendation server 14 generates the user profile 34-1 based on information from the user device 16-1.

Based on the user profile 34-1, the service recommendation function 24 generates a service recommendation for the user 28-1 of the user device 16-1 (step 210). The service recommendation may include scores or rankings of all of the subscription media services 12-1 through 12-N, scores or rankings for one or more of the subscription media services 12-1 through 12-N having scores or rankings above a predetermined threshold or having the top X scores where X is some desired number, or information identifying one or more of the subscription media services 12-1 through 12-N recommended for the user 28-1.

In one embodiment, the service recommendation function 24 generates the service recommendation by comparing the user profile 34-1 to the service profiles of the subscription media services 12-1 through 12-N. More specifically, the service recommendation function 24 may score or rank the subscription media services 12-1 through 12-N based on comparisons of the user profile 34-1 to the service profiles of the subscription media services 12-1 through 12-N. In order to perform the comparisons, the service recommendation function 24 compares the media items in the media collection 32-1 and optionally information inferred from the media items in the media collection 32-1 such as preferred genre, preferred artists, preferred time period, statistical information, or the like to the media items or statistical information describing the media items in the catalogs 20-1 through 20-N of the subscription media services 12-1 through 12-N. In this embodiment, the service recommendation function 24 also compares the media recommendations to the media items in the catalogs 20-1 through 20-N of the subscription media services 12-1 through 12-N. In addition, the service recommendation function 24 may compare the user preferences related to the desired use of media items by the user 28-1 in the user profile 34-1 to the terms 22-1 through 22-N of the subscription media services 12-1 through 12-N. Based on these comparisons, the service recommendation function 24 scores or ranks each of the subscription media services 12-1 through 12-N.

In another embodiment, the service recommendation function 24 may additionally or alternatively consider previous service recommendations to other users having biographical information and/or demographic information similar to that of the user 28-1. This may be particularly beneficial if the user 28-1 does not have a media collection, or if the number of media items in the media collection 32-1 is less than some minimum value such as, for example, ten media items.

Again, note that in one embodiment, the user 28-1 may assign weights to the different components of the user profile 34-1 to be used in generating the scores for the subscription media services 12-1 through 12-N. For example, the user 28-1 may assign greater weights to the information identifying the media items in the media collection 32-1, the user preferences related to intended use of media items, and media recommendations and lesser weights to the biographical information and demographic information. The service recommendation function 24 may then use the weights when generating scores or rankings for the subscription media services 12-1 through 12-N based on comparisons of the user profile 34-1 to the service profiles of the subscription media services 12-1 through 12-N.

Once the service recommendation is generated, the service recommendation function 24 of the recommendation server 14 sends the service recommendation to the user device 16-1 (step 212). Again, the service recommendation may include scores or rankings of all of the subscription media services 12-1 through 12-N, scores or rankings for one or more of the subscription media services 12-1 through 12-N having scores or rankings above a predetermined threshold or having the top X scores where X is some desired number, or information identifying one or more of the subscription media services 12-1 through 12-N recommended for the user 28-1. In response to receiving the service recommendation, the client 30-1 may optionally enable the user 28-1 to register with one or more of the subscription media services 12-1 through 12-N as desired by the user 28-1.

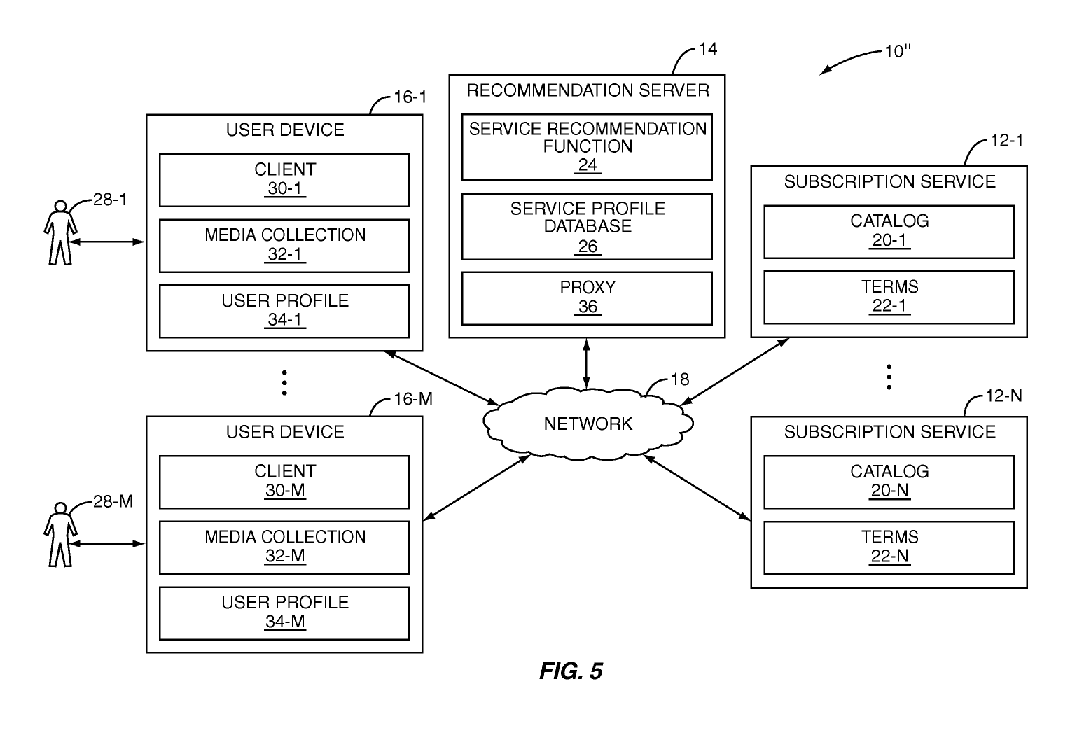

FIG. 5 illustrates a third embodiment of the system 10″. This embodiment is substantially the same as that discussed above with respect to FIGS. 3 and 4. However, the recommendation server 14 further includes a proxy function 36 that operates as an intermediary for the exchange of the P2P media recommendations among the user devices 16-1 through 16-M. Further, since the proxy function 36 is part of the recommendation server 14, the proxy function 36 may operate to store the media recommendations as an alternative to storing the media recommendations as part of the user profile 34-1. However, it should be noted that while the proxy function 36 is hosted by the recommendation server 14 in this embodiment, the present invention is not limited thereto. The proxy function 36 may alternatively be hosted by a separate server.

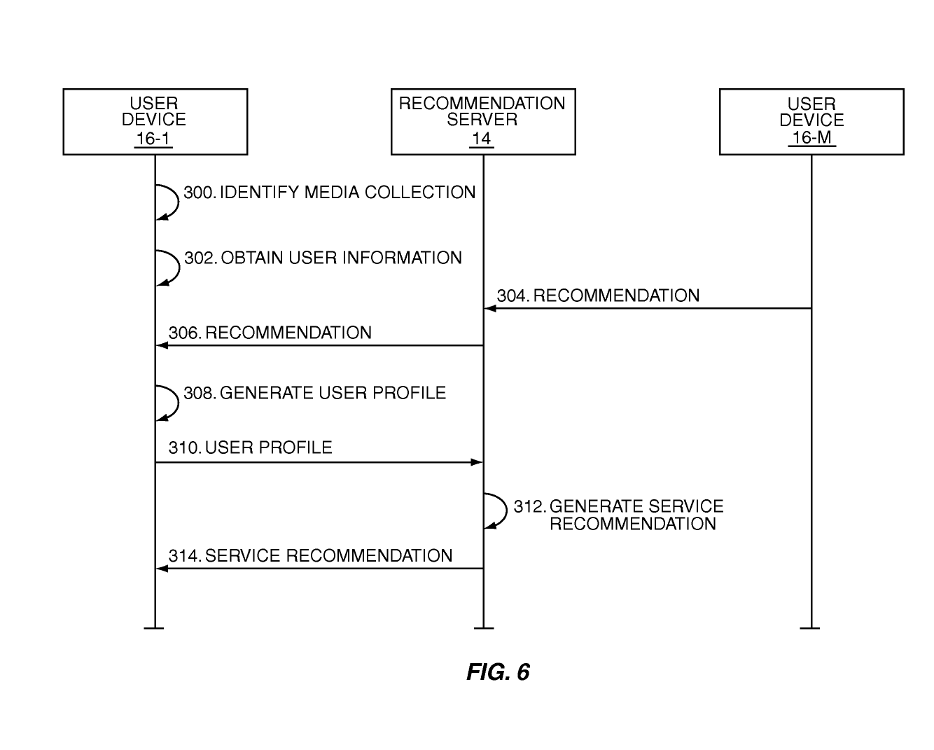

FIG. 6 illustrates the operation of the system 10″ of FIG. 5 according to one embodiment of the present invention. Note that while not illustrated for clarity, the service recommendation function 24 obtains the catalog information identifying the media items in the catalogs 20-1 through 20-N and the terms 22-1 through 22-N from the subscription media services 12-1 through 12-N at some point either before or during the illustrated process.

As discussed above, the client 30-1 of the user device 16-1 identifies the media collection 32-1 or more specifically the media items in the media collection 32-1 (step 300) and optionally obtains the user information (step 302). In addition, the user device 16-M provides a media recommendation to the user device 16-1 via the proxy function 36 of the recommendation server 14 (steps 304-306). The media recommendation identifies one or more media items that are recommended to the user 28-1. The client 30-1 then generates the user profile 34-1 for the user 28-1 (step 308). In this embodiment, the user profile 34-1 includes the media recommendations from the user device 16-M and optionally one or more prior media recommendations from the user device 16-M and/or other user devices. In addition, the user profile 34-1 may include information identifying the media items in the media collection 32-1, the user information, and information inferred from the media items in the media collection 32-1 such as, for example, preferred genres, preferred artists, preferred time periods, genre distribution, artist distribution, time period distribution, or the like.

The user device 16-1 then sends the user profile 34-1 to the recommendation server 14 (step 310). Again, it should be noted that while, in this example, the client 30-1 generates the user profile 34-1, the present invention is not limited thereto. In an alternative embodiment, the recommendation server 14 generates the user profile 34-1.

As discussed above, the service recommendation function 24 generates the service recommendation for the user 28-1 of the user device 16-1 based on the user profile 34-1 including the media recommendations provided to the user device 16-1 (step 312). The service recommendation may include scores or rankings of all of the subscription media services 12-1 through 12-N, scores or rankings for one or more of the subscription media services 12-1 through 12-N having scores or rankings above a predetermined threshold or having the top X scores where X is some desired number, or information identifying one or more of the subscription media services 12-1 through 12-N recommended for the user 28-1. Once the service recommendation is generated, the service recommendation function 24 of the recommendation server 14 sends the service recommendation to the user device 16-1 (step 314). In response to receiving the service recommendation, the client 30-1 may optionally enable the user 28-1 to register with one or more of the subscription media services 12-1 through 12-N as desired by the user 28-1.

It should be noted that while FIGS. 3-6 focus on P2P media recommendations, the present invention is not limited thereto. The service recommendation function 24 may alternatively consider media recommendations provided to the user device 16-1 from a remote server having a media recommendation function.

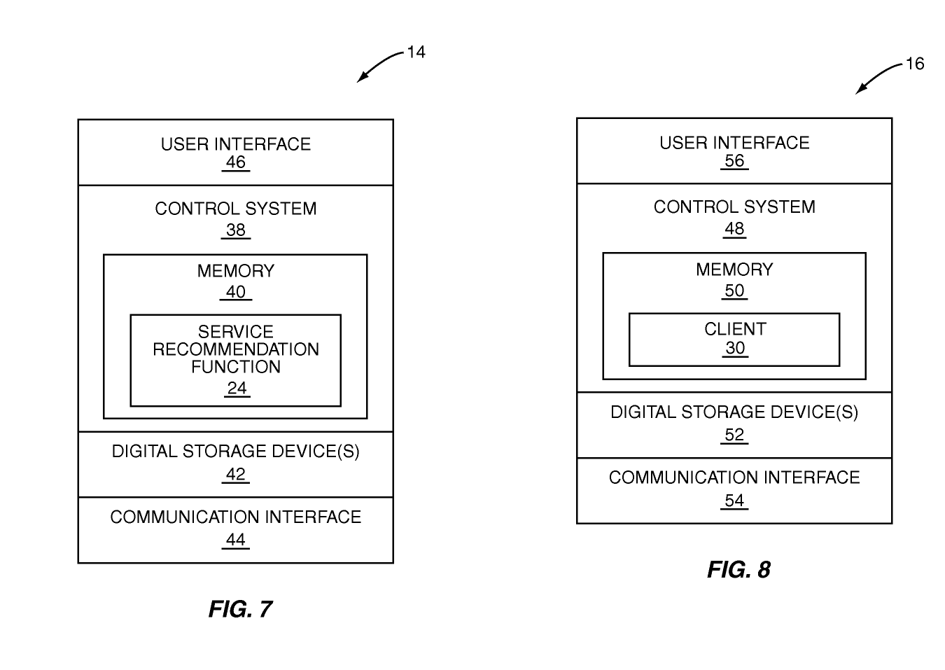

FIG. 7 is a block diagram of the recommendation server 14 of FIGS. 1-4 according to one embodiment of the present invention. However, this discussion is also applicable to the recommendation server 14 of FIGS. 5 and 6. The recommendation server 14 includes a control system 38 having associated memory 40. In this example, the service recommendation function 24 is implemented in software and stored in the memory 40. In addition, with respect to the embodiment of the recommendation server 14 shown in FIG. 5, the proxy function 36 may also be implemented in software and stored in memory 40. The recommendation server 14 may also include one or more digital storage devices 42 such as, for example, one or more hard disc drives, one or more optical storage devices, or the like. The service profile database 26 may be stored in the one or more digital storage devices 42. The recommendation server 14 also includes a communication interface 44 communicatively coupling the recommendation server 14 to the network 18. The recommendation server 14 may also include a user interface 46, which may include one or more components such as a display, user input devices, and the like.

FIG. 8 is a block diagram of the user device 16 of FIGS. 1 and 2 according to one embodiment of the present invention. Note that this discussion is equally applicable to the user devices 16-1 through 16-M of FIGS. 3-6. In general, the user device 16 includes a control system 48 having associated memory 50. In this example, the client 30 is implemented in software and stored in memory 50. The user device 16 may also include one or more digital storage devices 52 such as, for example, one or more hard disc drives, one or more optical storage devices, or the like. The media collection 32 (FIG. 1) and the user profile 34 (FIG. 1) may each be stored in the memory 50 or the one or more digital storage devices 52. The user device 16 also includes a communication interface 54 communicatively coupling the user device 16 to the network 18. The user device 16 also includes a user interface 56, which may include components such as, for example, a display, one or more user input devices, speakers, and the like.

Those skilled in the art will recognize improvements and modifications to the preferred embodiments of the present invention. All such improvements and modifications are considered within the scope of the concepts disclosed herein and the claims that follow.

What is claimed is:

1. A method of recommending a subscription media service to a user comprising:
generating a service recommendation identifying at least one subscription media service for the user based on a user profile of the user; and
providing the service recommendation to a user device associated with the user.

2. The method of claim 1 wherein the user profile comprises information identifying media items in a media collection of the user stored at the user device.

3. The method of claim 2 further comprising:
obtaining catalog information identifying media items available from each of a plurality of subscription media services including the at least one subscription media service;
wherein generating the service recommendation comprises generating the service recommendation based on comparisons of the information identifying the media items in the media collection of the user and the catalog information identifying the media items available from each of the plurality of subscription media services.

4. The method of claim 2 further comprising:
analyzing the information identifying the media items in the media collection of the user to determine preferences of the user; and
obtaining catalog information identifying media items available from each of a plurality of subscription media services including the at least one subscription media service;
wherein generating the service recommendation comprises generating the service recommendation based on comparisons of the preferences of the user and the catalog information identifying the media items available from each of the plurality of subscription media services.

5. The method of claim 4 wherein analyzing the information identifying the media items in the media collection of the user comprises analyzing the information identifying the media items in the media collection of the user to determine at least one of a group consisting of: at least one preferred music genre of the user, at least one preferred artist of the user, at least one preferred movie genre of the user, at least one preferred television genre of the user, at least one preferred actor of the user, and at least one preferred time period of the user.

6. The method of claim 2 further comprising:
analyzing the information identifying the media items in the media collection of the user to provide statistical information describing the media collection of the user; and
obtaining catalog information identifying media items available from each of a plurality of subscription media services including the at least one subscription media service;
wherein generating the service recommendation comprises generating the service recommendation based on comparisons of the statistical information describing the media collection of the user and the catalog information identifying the media items available from each of the plurality of subscription media services.

7. The method of claim 6 wherein the statistical information comprises at least one of a group consisting of: a genre distribution, an artist distribution, and a time period distribution.

8. The method of claim 2 further comprising:
analyzing the information identifying the media items in the media collection of the user to provide statistical information describing the media collection of the user; and
obtaining statistical information describing media items available from each of a plurality of subscription media services including the at least one subscription media service;
wherein generating the service recommendation comprises generating the service recommendation based on comparisons of the statistical information describing the media collection of the user and the statistical information describing the media items available from each of the plurality of subscription media services.

9. The method of claim 1 wherein the user profile comprises user preferences regarding an intended use of media items by the user, and the method further comprises:
obtaining terms of use of a plurality of subscription media services including the at least one subscription media service;
wherein generating the service recommendation comprises generating the service recommendation based on comparisons of the user preferences regarding the intended use of media items by the user and the terms of use of each of the plurality of subscription media services.

10. The method of claim 1 wherein the user profile includes media recommendations provided to the user.

11. The method of claim 1 wherein the user profile comprises biographical information describing the user, and generating the service recommendation comprises generating the service recommendation based on previous service recommendations made to other users having biographical information that is substantially similar to the biographical information of the user.

12. The method of claim 1 wherein the user profile comprises demographic information describing the user, and generating the service recommendation comprises generating the service recommendation based on previous service recommendations made to other users having demographic information that is substantially similar to the demographic information of the user.

13. The method of claim 1 wherein generating the service recommendation comprises generating a score for each of a plurality of subscription media services including the at least one subscription media service based on the user profile of the user, wherein the service recommendation comprises the scores of the at least one subscription media service.

14. The method of claim 13 wherein the user profile comprises at least two types of information selected from a group consisting of: information identifying media items in a media collection of the user, biographical information describing the user, demographic information describing the user, media recommendations received by the user, and user preferences related to intended uses of media items by the user, and generating the score for each of the plurality of subscription media services comprises generating the score for each of the plurality of subscription media services based on weights assigned to each of the at least two types of information by the user.

15. The method of claim 1 wherein generating the service recommendation comprises:
generating a score for each of a plurality of subscription media services including the at least one subscription media service; and
selecting the at least one subscription media service from the plurality of subscription media services based on the scores.

16. A recommendation server comprising:
a) a communication interface communicatively coupling the recommendation server to a user device associated with a user via a network; and
b) a control system associated with the communication interface and adapted to:
i) generate a service recommendation identifying at least one subscription media service for the user based on a user profile of the user; and
ii) provide the service recommendation to the user device associated with the user.

17. The recommendation server of claim 16 wherein the user profile comprises information identifying media items in a media collection of the user stored at the user device associated with the user.

18. The recommendation server of claim 17 wherein the control system is further adapted to:
obtain catalog information identifying media items available from each of a plurality of subscription media services including the at least one subscription media service; and
generate the service recommendation based on comparisons of the information identifying the media items in the media collection of the user and the catalog information identifying the media items available from each of the plurality of subscription media services.

19. The recommendation server of claim 17 wherein the control system is further adapted to:
analyze the information identifying the media items in the media collection of the user to determine preferences of the user;
obtain catalog information identifying media items available from each of a plurality of subscription media services including the at least one subscription media service; and
generate the service recommendation based on comparisons of the preferences of the user and the catalog information identifying the media items available from each of the plurality of subscription media services.

20. The recommendation server of claim 19 wherein the preferences of the user comprise at least one of a group consisting of: at least one preferred music genre of the user, at least one preferred artist of the user, at least one preferred movie genre of the user, at least one preferred television genre of the user, at least one preferred actor of the user, and at least one preferred time period of the user.

21. The recommendation server of claim 17 wherein the control system is further adapted to:
analyze the information identifying the media items in the media collection of the user to provide statistical information describing the media collection of the user;
obtain catalog information identifying media items available from each of a plurality of subscription media services including the at least one subscription media service; and
generate the service recommendation based on comparisons of the statistical information describing the media collection of the user and the catalog information identifying the media items available from each of the plurality of subscription media services.

22. The recommendation server of claim 21 wherein the statistical information comprises at least one of a group consisting of: a genre distribution, an artist distribution, and a time period distribution.

23. The recommendation server of claim 17 wherein the control system is further adapted to:
analyze the information identifying the media items in the media collection of the user to provide statistical information describing the media collection of the user;
obtain statistical information describing media items available from each of a plurality of subscription media services including the at least one subscription media service; and
generate the service recommendation based on comparisons of the statistical information describing the media collection of the user and the statistical information describing the media items available from each of the plurality of subscription media services.

24. The recommendation server of claim 16 wherein the user profile comprises user preferences regarding an intended use of media items by the user, and the control system is further adapted to:
obtain terms of use of a plurality of subscription media services including the at least one subscription media service; and
generate the service recommendation based on comparisons of the user preferences regarding the intended use of media items by the user and the terms of use of each of the plurality of subscription media services.

25. The recommendation server of claim 16 wherein the user profile includes media recommendations provided to the user.

26. The recommendation server of claim 16 wherein the user profile comprises biographical information describing the user, and the control system is further adapted to generate the service recommendation based on previous service recommendations made to other users having biographical information that is substantially similar to the biographical information of the user.

27. The recommendation server of claim 16 wherein the user profile comprises demographic information describing the user, and the control system is further adapted to generate the service recommendation based on previous service recommendations made to other users having demographic information that is substantially similar to the demographic information of the user.

28. The recommendation server of claim 16 wherein in order to generate the service recommendation, the control system is further adapted to generate a score for each of a plurality of subscription media services including the at least one subscription media service, wherein the service recommendation comprises the scores of the at least one subscription media service.

29. The recommendation server of claim 28 wherein the user profile comprises at least two types of information selected from a group consisting of: information identifying media items in a media collection of the user, biographical information describing the user, demographic information describing the user, media recommendations received by the user, and user preferences related to intended uses of media items by the user, and the control system is further adapted to generate the score for each of the plurality of subscription media services based on weights assigned to each of the at least two types of information by the user.

30. The recommendation server of claim 16 wherein in order to generate the service recommendation, the control system is further adapted to:
generate a score for each of a plurality of subscription media services including the at least one subscription media service; and
select the at least one subscription media service from the plurality of subscription media services based on the scores.
